(19) United States
(12) Patent Application Publication
(10) Pub. No.: US 2008/0028668 A1
(43) Pub. Date: Feb. 7, 2008

(54) Device for Repelling Animals

(76) Inventor: Walter Pollman, Herborn-Horbach (DE)

Correspondence Address: Blakely, Sokoloff, Taylor & Zafman llp, 12400 Wilshire Boulevard , 7th floor, Los Angeles, CA, 90025, US

(21) Appl. No.: 11/578,272

(22) PCT Filed: Mar. 9, 2005
(86) PCT No.: PCT/EP05/02475

§ 371 Date: Jul. 24, 2007

(30) Foreign Application Priority Data
Apr. 27, 2004 (DE) 20 2004 006 747.1

(51) Int. Cl. A01M 29/00; A01M 1/22

(52) U.S. Cl. 43/112; 116/22 A; 361/232

(57) ABSTRACT

The invention relates to a device (1) for repelling animals, especially insects. Said device (1) comprises a support element (2) on which at least two wire branches are provided. A voltage can be applied between said wire branches which are made of a current-conductive plastic material.

The invention pertains to a device for repelling animals, especially insects. The device comprises a support element, on which at least two wire branches are provided, between which a voltage can be applied.

The term animals can primarily include animal pests, which cause damage to the human and to his economy in the broadest sense. These animal pests can thereby primarily, but not exclusively, be insects. Termites and ants, for example, are a group of animal pests, which pose a threat, which is to be taken seriously, to buildings, or parts of buildings. Primarily buildings made of wood or wood components are threatened by these insects, because termites, for example, can also destroy supporting constructions components within a few days.

It is primarily known for the building protection to combat termites and other pests with chemical means, especially toxins. Due to the adverse environmental influences and the danger of the toxins entering into the human food chain and possible health damages connected therewith, the chemical/toxic combat of termites and similar animal pests, however, is extremely problematic, for example in growing areas. This method thus entails considerable ecological disadvantages and is also costly, due to the high prices for the insecticides. A further disadvantage is based on the fact that, after a certain period of time, the insects can again migrate back into their environment, so that insecticides must then again be sprayed.

In consideration of the known state of the art, the invention is based on the object of creating a device for repelling animals, especially insects, whereby the specific combat of animals is possible, with the utilization of at least two wire branches, with relatively small effort and a high effectiveness.

According to the invention, this object is solved according to the preamble of claim 1.

Advantageous embodiments of the invention are the objects of the subclaims.

To successfully repel animals, especially insects, the device according to the invention has at least two wire branches, which are made of a current-conductive plastic material. By means of these current-conductive wire branches it is possible to create a device for repelling animals, which completely abstains from the use of chemical/toxic combat means. A further advantage of the device is based on the fact that it can be made with very simple means, whereby a reliable functionality of the device can be ensured.

To further increase the reliability of operation of the device, provision can be made in the wire branch for at least one electric wire body, whereby the wire branch encloses the wire body substantially holohedrally. This has the advantage that an oxidation of the wire body is not possible, because the wire body is completely embedded in the wire branch.

Advantageously, the wire body can thus be cast in the wire branch or can be provided in the wire branch in a similar manner. A further advantage of such an embedding is that, by means of the surface of the wire branch, it is not discernable, where precisely the conducting wire body is located.

To ensure a power supply of the wire branch or of the wire body, the wire branch and/or the wire body can be indirectly and/or directly connected to a voltage source. The optimal voltage for the wire branch and/or for the wire body can thereby be in the range of between 1000 to 3000 volts.

The connection of the wire branch and/or of the wire body to the voltage source can thereby be effected via a clip connection, whereby the clip has at least two, especially four contact pins, for example.

It is further possible that the clip can be used as connection element between two wire branches, which are to be connected with one another.

The advantage of such a clip connection is based on the very simple handling or on the high reliability of operation of such a clip.

The electric wire body itself can be embodied like a wire strand and/or a metal foil. If the electric wire body is embodied as a metal foil, it can preferably be a nickel-coated copper foil. The advantages of such a nickel-coated copper foil are based on the extremely high conductivity of such a copper foil.

The metal foil itself can be embodied to be between 0.1 mm and 0.5 mm strong, preferably, however, 0.2 mm. The width of such a metal foil can be between 1 cm and 10 cm, preferably, however, 3 cm.

Depending on the embodiment of the wire branch or of the voltage, which is to be transferred, the metal foil can certainly also be made in other dimensions. According to the invention, however, it is not important in which manner the metal foil is made.

The support element of the device can be made of a flexible plastic material, especially, however, of PVC. The advantage of such an embodiment would especially be based on that the support element can be simply molded at corners or curvatures. Especially PVC permits a very simple production of such a support element and has a high weather resistance.

A preferred embodiment of the device provides that provision can be made at the support element for at least one groove, into which a wire branch can be placed, whereby the groove can substantially be embodied form-complementary to the wire branch. The advantage of such a groove in the support element or of a wire branch provided in the groove is based on the fact that the device could have an absolutely even surface, which would make it impossible for the insects to latch on the top side of the device. The mounting of a wire branch in a groove or in the connection of the power conduction sources, which are provided in the device, can be put into effect, for example, by a clip fastener or the like. Other methods of fastening are certainly also possible.

To facilitate the passage or the climbing onto the device for the animals, at least a partial region of the support element can be embodied in a slightly beveled manner and can be provided with a slant. This has the advantage that integration of the device or of the support element into the ground is simpler, whereby a higher functionality of the device can be ensured.

A particularly preferred embodiment of the device provides that the exterior of the device, which is embodied by the support element and by the wire branch, can represent a flat surface. This has the advantage that dirt or insects cannot accumulate in the spaces between the grooves. The device can thus be considered to be virtually maintenance-free.

The invention will be explained below in more detail by means of drawings showing only exemplary embodiments.

It is shown:

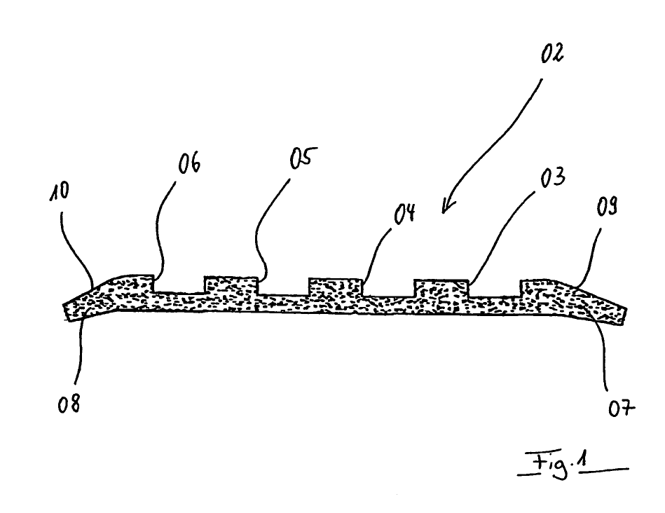

FIG. 1 a support element in lateral sectional view;

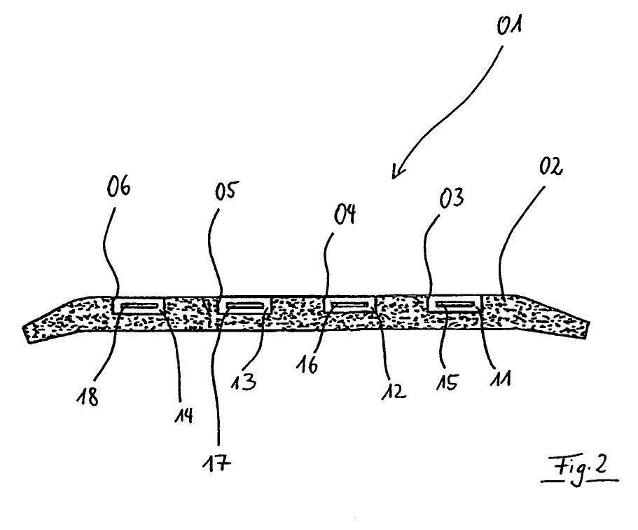

FIG. 2 a device with the support element according to FIG. 1 in a lateral sectional view;

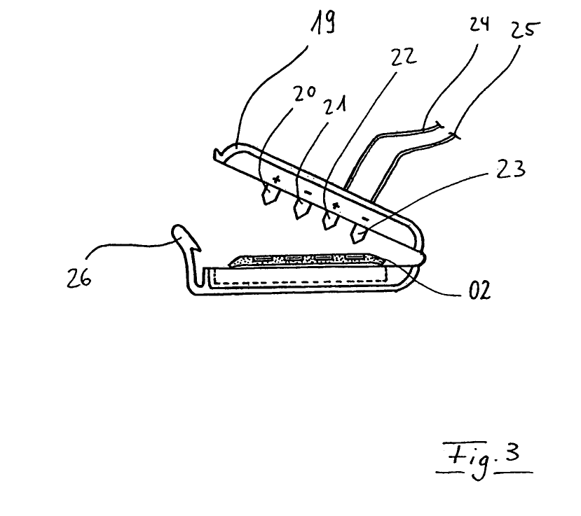

FIG. 3 a clip in a lateral view.

The lateral sectional view of a support element 02 can be seen in FIG. 1. Four grooves 03, 04, 05, 06, which substantially completely pass through the support element 02, are provided in the support element 02. Furthermore, the support element 02 has slightly beveled partial regions 07, 08, whereby the partial regions are provided with a slant 09, 10. The mounting of the slightly beveled partial regions 07 and 08 or of the slants 09 and 10, which are mounted at the beveled partial regions 07 and 08, are to facilitate the passage of the support element for the animals.

FIG. 2 shows a device 01 with the support element 02 in a lateral sectional view. Wire branches 11, 12, 13, 14, which are embodied in a substantially form-complementary manner to the grooves 03, 04, 05, 06, are provided in the support element 02 or in the grooves 03, 04, 05, 06. An even surface of the support element 02 can be achieved with such a configuration of the wire branches 11, 12, 13, 14 in the grooves 03, 04, 05, 06, which makes it impossible for the animals to latch on the support element 02 or on the wire branches 11, 12, 13, 14. Furthermore, the device 01 can thus be better protected against impurities.

Wire bodies 15, 16, 17, 18, which are substantially completely embedded in the wire branches 11, 12, 13, 14, are provided in the wire branches 11, 12, 13, 14. The wire bodies 15, 16, 17, 18 are hereby embodied like a metal foil. The wire branches 11, 12, 13, 14 can be connected with the support element 02 via a simple clip fastener. Extensive connection operations of the wire branches 11, 12, 13, 14 or of the wire bodies 15, 16, 17, 18 could thus be completely avoided.

FIG. 3 shows a clip 19 in a lateral view. Contact pins 20, 21, 22, 23, which are connected with a voltage source via connecting conductors 24, 25, are provided on the clip 19. The clip 19 can be locked via a click lever connection 26. As an alternative, a screw connection can also be provided. According to FIG. 2, the support element 02 can be seen in the clip 19. If the clip 19 is locked by means of the click lever connection 26, the contact pins 20, 21, 22, 23 come into contact with the wire branches and/or with the wire bodies, which are provided in the support element 02, whereby the support element 02 can be supplied with a current. By means of a suitable shaping of the free end of the contact pins 20, 21, 22, 23, for example by forming a tip, it can be achieved that the contact pins 20, 21, 22, 23 penetrate into the wire branches and thus contact the wire bodies 15, 16, 17, 18, which are embedded in the wire branches.

1. A device (01) for repelling animals, especially insects, which comprises a support element (02), at which at least two wire branches (11, 12, 13, 14) are provided, between which a voltage can be applied,
characterized in
that the wire branches (11, 12, 13, 14) are made of a current-conductive plastic material.

2. The device according to claim 1,
characterized in
that at least one electric wire body (15, 16, 17, 18) is provided in the wire branch (11, 12, 13, 14), whereby the wire branch (11, 12, 13, 14) encloses the wire body (15, 16, 17,18) substantially holohedrally.

3. The device according to claim 2,
characterized in
that the wire body (15, 16, 17, 18) is cast in the wire branch (11, 12, 13, 14).

4. The device according to claim 1,
characterized in
that the wire branch (11, 12, 13, 14) and/or the wire body (15, 16, 17, 18) can be connected indirectly and/or directly to a voltage source.

5. The device according to claim 1,
characterized in
that the connection of the wire branch (11, 12, 13, 14) and/or of the wire body (15, 16, 17, 18) to a voltage source can be effected via a clip connection, whereby the clip 19 has at least two contact pins (20, 21, 22, 23).

6. The device according to claim 5,
characterized in
that the clip (19) can be used as connection element between at least two wire branches (11, 12, 13, 14), which are to be connected with one another.

7. The device according to claim 2,
characterized in
that the electric wire body (15, 16, 17, 18) is embodied like a wire strand and/or a metal foil.

8. The device according to claim 7,
characterized in
that the metal foil is a nickel-coated copper foil.

9. The device according to claim 7,
characterized in
that the metal foil is embodied to be between 0.1 mm and 0.5 mm strong, preferably, however, 0.2 mm.

10. The device according to claim 7,
characterized in
that the width of the metal foil is embodied to be between 1 cm and 10 cm, preferably, however, 3 cm.

11. The device according to claim 1,
characterized in
that the support element (02) is made of a flexible plastic material, especially, however, of PVC.

12. The device according to claim 1,
characterized in
that provision is made at the support element (02) for at least one groove (03, 04, 05, 06), into which the wire branch (11, 12, 13, 14) can be placed, whereby the groove (03, 04, 05, 06) can substantially be embodied form-complementary to the wire branch (11, 12, 13, 14).

13. The device according to claim 1,
characterized in
that at least a partial region (07, 08) of the support element (02) can be embodied in a slightly beveled manner and can be provided with a slant (09, 10).

14. The device according to claim 1,
characterized in
that the exterior of the device (01), which is embodied by the support element (02) and by the wire branch (11, 12, 13, 14), can represent a flat surface.
